(19) United States
(12) Patent Application Publication
(10) Pub. No.: US 2024/0419426 A1
(43) Pub. Date: Dec. 19, 2024

(54) UPDATING CLUSTERED STORAGE SOFTWARE BASED ON POD PRIORITIES

(71) Applicant: International Business Machines Corporation, Armonk, NY (US)

(72) Inventors: Scott Miller, Meadville, PA (US); Joseph Evan Dunn, Tucson, AZ (US)

(21) Appl. No.: 18/210,932

(22) Filed: Jun. 16, 2023

(51) Int. Cl. G06F 8/65

(52) U.S. Cl. CPC G06F 8/65

(57) ABSTRACT

A computer-implemented method, according to one embodiment, includes collecting information from a storage cluster associated with pod deletion candidacy, and selecting a pod for deletion based on pod priorities determined using the collected information. The method further includes marking a node associated with the selected pod as not schedulable, draining the node of application workloads, and deleting the selected pod. The selected pod is recreated with a new configuration and the recreated pod is updated with updated storage software. The method further includes marking the node as schedulable. A computer program product, according to another embodiment, includes a computer readable storage medium having program instructions embodied therewith. The program instructions are readable and/or executable by a computer to cause the computer to perform the foregoing method.

### BACKGROUND

The present invention relates to container orchestration systems, and more specifically, this invention relates to updating clustered storage software based on pod priorities.

Automation to perform repeatable tasks is often implemented on workloads that are run on a container orchestration system, e.g., such as Kubernetes which is designed for automation. Kubernetes is a container orchestration platform for scheduling and automating the deployment, management, and scaling of containerized applications.

Kubernetes is sometimes deployed as a managed and orchestrated (cloud) environment that includes distributed storage clusters that use and maintain a clustered file system. These distributed storage clusters provide storage to the Kubernetes ecosystem.

### SUMMARY

A computer-implemented method, according to one embodiment, includes collecting information from a storage cluster associated with pod deletion candidacy, and selecting a pod for deletion based on pod priorities determined using the collected information. The method further includes marking a node associated with the selected pod as not schedulable, draining the node of application workloads, and deleting the selected pod. The selected pod is recreated with a new configuration and the recreated pod is updated with updated storage software. The method further includes marking the node as schedulable.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

FIGS. 4A-4E depict updates performed in an orchestrated environment, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for updating clustered storage software based on pod priorities.

In one general embodiment, a computer-implemented method includes collecting information from a storage cluster associated with pod deletion candidacy, and selecting a pod for deletion based on pod priorities determined using the collected information. The method further includes marking a node associated with the selected pod as not schedulable, draining the node of application workloads, and deleting the selected pod. The selected pod is recreated with a new configuration and the recreated pod is updated with updated storage software. The method further includes marking the node as schedulable.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as clustered storage software update code of block 150 for updating clustered storage software based on pod priorities. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

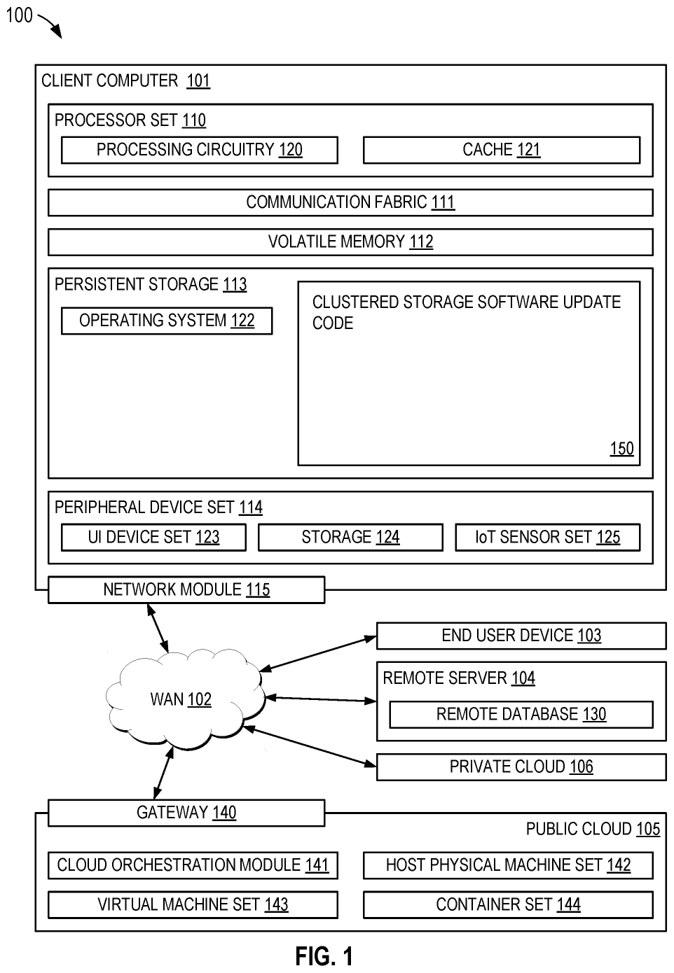

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

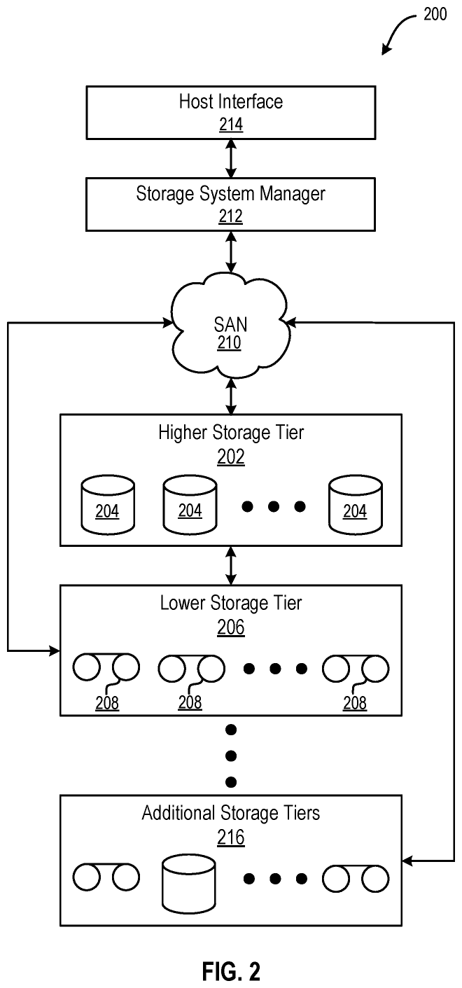

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, automation to perform repeatable tasks is often implemented on workloads that are run on a container orchestration system, e.g., such as Kubernetes which is designed for automation. Kubernetes is a container orchestration platform for scheduling and automating the deployment, management, and scaling of containerized applications.

Kubernetes is sometimes deployed as a managed and orchestrated (cloud) environment that includes distributed storage clusters that use and maintain a clustered file system. These distributed storage clusters provide storage to the Kubernetes ecosystem.

Updates and configuration changes are typically ongoingly performed on both storage and infrastructure software of the managed and orchestrated environment. These updates involve outages of the software on corresponding systems in each cluster and thus affect availability and potential data redundancy. Conventionally managed and orchestrated environments deploy “best-guess effort” techniques when performing these updates, which often results in a relatively excessive number of pod restarts being performed. This is because these conventional techniques do not treat external updates performed on nodes of the environment differently from internal updates performed on nodes of the environment. Without this distinction, a cause of an update performed on the nodes is typically unknown, which leads to pods being unnecessarily restarted in the process of an update being performed. The available storage potential of the orchestrated environment in addition to storage processing resources are compromised in each instance of pods being unnecessarily restarted in the process of an update being performed. Furthermore, these conventional techniques fail to prioritize clustered software requirements during the disruption process of performing updates. These techniques also do not include a mechanism to understand which software is to be updated (storage vs orchestration framework).

In sharp contrast to the deficiencies of the conventional techniques described above, the techniques of embodiments and approaches described herein protect storage clusters in managed and orchestrated (cloud) environments from loss of data and availability during updates/configuration changes to both storage and infrastructure software.

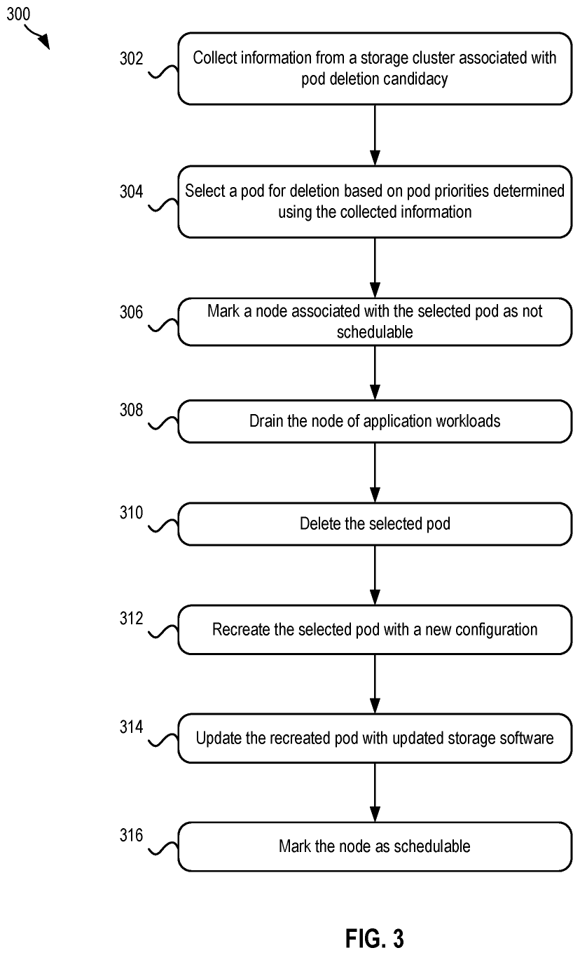

Now referring to FIG. 3, a flowchart of a method 300 is shown according to one embodiment. The method 300 may be performed in accordance with the present invention in any of the environments depicted in FIGS. 1-4E, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 may, in some preferred approaches, be performed in an orchestrated environment. The orchestrated environment may, in some preferred approaches, serve as a containerized offering of a relatively high performance clustered file system stored across a clustered storage system of the orchestrated environment. More specifically, in one or more of such approaches, the clustered file system is used to, at least in part, provide storage to a Kubernetes ecosystem. In some approaches, the Kubernetes ecosystem may include a container storage interface (CSI) specification that is used to implement an interface that is used to provision storage from the clustered file system into Kubernetes volumes. Kubernetes includes the concept of persistent volumes and persistent volume claims, which interact with the specification that eventually maps down into storage.

In some deployments, the file system may interact with nodes of the orchestrated environment. For example, in some approaches, the file system may be managed, maintained and/or accessed using a predetermined plurality of nodes. Note that in some approaches, the nodes may be computing nodes which may be, e.g., a processing circuit, a computer, a processor, a virtual machine, etc. The file system may have stateful requirements, e.g., a storage pod of a node which may be a stateful pod. Each of such nodes may additionally and/or alternatively include a storage driver that may be a CSI component of the node. Furthermore, each node may include applications and a kernel module that enables the node to interact with an operating system for, e.g., mounting the file system inside the kernel. Such a kernel module may be relatively important for some of the stateful aspects in that kernel modules tend to be relatively stateful in general and particularly with respect to file systems in the context of Kubernetes. For example, typically with a file system outside of Kubernetes, there may exist a single mount point which may be navigated through the kernel and is thereafter mounted. In contrast, in Kubernetes, every application's volume has its own mount. Accordingly, any stale mounts or mounts that cannot be seen inside of the storage pod need to be cleared. For example, assuming that one or more applications cannot be cleared, the kernel may be cycled with a node reboot. This clearing of application(s) from one or more nodes allows for storage updates and/or other ecosystem updates to be performed. For example, these updates may include Kubernetes updates, administrator updates, etc., Various operations of method 300 ensure that, in the process of updating clustered storage software, there is an ordering guaranteed in the draining of a pod for updating a node, the applications that are dependent on the storage provider are removed first, and disruption of the storage system is avoided.

Various operations of method 300 involve two main categories of updates. The first update category is storage updates, which is a subset of the second update category which is orchestration framework updates.

Depending on the approach, containerized storage software may be updated for a number of reasons. For example, these reasons may include, e.g., configuration changes, storage software version upgrades, pod specification updates, etc. These updates may call for a pod to restart and the storage software to be disrupted. Accordingly, in some approaches, method 300 includes performing one or more operations for determining a pod for deletion. In order to determine a pod for deletion, in some approaches, a priority of the pods may be established. Operation 302 includes collecting information from a storage cluster associated with pod deletion candidacy. In other words, information associated with a plurality of candidate pods is gathered to use for determining a relatively best deletion candidate. For example, in one or more of such approaches, during storage updates, a module that manages and/or has access to information associated with the deployment of the pods of the orchestrated environment may be caused, e.g., instructed, to provide information about the storage cluster into a priority queue structure that can be used to determine which of a plurality of pod requiring an update to use for the deletion.

The information collected from the storage cluster associated with pod deletion candidacy may depend on the approach. In some approaches, the information details whether a given pod is already scheduled to be terminated. The information may additionally and/or alternatively detail whether a given pod has succeeded or failed and/or whether a given pod is currently unscheduled and/or pending. In some other approaches, the information may additionally and/or alternatively detail whether a given pod is on a node that was previously cordoned for storage software update, the given pod is on a node currently cordoned by someone and/or something else, etc. The information may additionally and/or alternatively include timestamp information, e.g., when the pod was created, when the pod was last used, when the pod was last updated, etc. In some other approaches, the information may additionally and/or alternatively detail current versions of programs and/or protocols that the pod currently and/or has previously adhered to.

Method 300 may include inserting the information in a predetermined priority queue structure for determining the pod priorities. The predetermined priority queue structure may be of a type that would become apparent to one of ordinary skill in the art after reading the descriptions herein. For context, the priority queue, e.g., “delete queue”, is used to determine which pods are safe to delete, e.g., update. The predetermined priority queue structure is, in some preferred approaches, configured to use the collected information to determine the pod priorities. In some approaches, the pod priorities are determined and thereby based on a count of checks registered with the priority queue structure. The predetermined priority queue structure determines such priorities by considering an overall safety of deleting a pod with respect to a number of checks that are registered with the queue structure. The checks may be static, e.g., data at the time of registration, and/or dynamic, e.g., executed when sorting the queue. In one preferred approach, the checks are both static and dynamic. Each check is ensured to implement an interface that receives a pod name as an argument and returns a safety margin for the named pod. Example checks include but are not limited to, e.g., unknown safety (in the event a check registration fails), and master node safety (so as not to reboot more than a single Kubernetes master node in order to preserve cluster availability of Kubernetes). The checks may additionally and/or alternatively include an n-pod safety which is a check that allows configurable aggressiveness to pod updates, e.g., drain/update “n” nodes at a time. In another approach, the checks may additionally and/or alternatively include a fault tolerance safety, e.g., Redundant Array of Independent Disks (RAID) protection for rebuild/rebalance of states as well as critical states where updating a pod would otherwise cause a data loss. Failure domain safety is another check that includes replicated storage checks which serves as another data loss prevention check. A consensus safety may additionally and/or alternatively be implemented in which cluster consensus algorithms must maintain a certain number of members to maintain consistency, e.g., such as a quorum in SPECTRUM SCALE by IBM which may use a Paxos consensus algorithm.

Operation 304 includes selecting a pod for deletion based on pod priorities determined using the collected information. In some approaches, in order to select the pod, the priority queue is caused, e.g., instructed, to aggregate registered safety checks and pop off a safe pod with a priority ordered from relatively highest priority to relatively lowest priority. For purposes of an example, an illustrative ordering of such priorities ordered from relatively highest priority to relatively lowest priority may include: a pod that is already terminating, a pod that has succeeded or failed, a pod that is currently unscheduled/pending, a pod on a node currently or previously cordoned for storage software update, a pod on a node currently cordoned by someone and/or something else, and a pod with a relatively oldest creation timestamp. In some preferred approaches, a pod with a relatively highest priority is selected. In some other approaches, a pod with a predetermined priority is selected, e.g., a pod with a second highest priority, a pod with a relatively lowest priority, etc.

Upon determining a relatively best candidate pod for deletion, a node associated with pod, e.g., the node on which software that is to be updated is running, may be cordoned, e.g., marked unschedulable. For example, operation 306 includes marking a node associated with the pod as not schedulable. In some approaches, the node associated with the selected pod is marked unschedulable automatically based on the associated pod being selected. In some other approaches, the node associated with the selected pod is marked unschedulable based on a received operator input.

Method 300 additionally includes draining, e.g., evicting, application workloads from the node associated with the selected pod, e.g., see operation 308. Techniques for draining application workloads from the node that would become apparent to one of ordinary skill in the art after reading the descriptions herein may be used.

Under normal circumstances, when a pod is popped off the queue, a pre-delete action is performed. The pre-delete action cordons the node and initiates a drain (moving application workload). Normal configuration updates will drain all storage-consuming applications before deleting the storage-providing pod. Image updates will drain all storage-consuming applications before attempting to unload the filesystem kernel module. If the kernel module cannot be unloaded, the remaining non-storage consuming applications on the node will be drained. In one preferred approach, the image updates perform the same updates as the configuration updates, e.g. drain only the storage applications. In such a preferred approach, an unload of the kmod may be attempted. In response to a determination that the kmod cannot be unloaded, the whole node may be caused to be drained for a reboot. In contrast, in response to a determination that the unload can be performed, then a reboot is not required, and the image update is caused to proceed the same as a configuration update. Once all storage-consuming and non-storage consuming applications have been relocated, the storage-providing pod will be deleted, and the node rebooted to unload the kernel module. In other words, once the node is cleared, the selected pod is deleted, e.g., see operation 310. All storage pod deletions are preferably caused, e.g., instructed, to be performed via the priority queue. Thereafter, the deleted selected pod is preferably recreated, e.g., see operation 312. The recreated pod is preferably updated with updated storage software, e.g., see operation 314. More specifically, the deleted selected pod is preferably recreated and updated with a new configuration that is different than a configuration that the selected pod had at a time before the deletion and/or at the time of the deletion. In some preferred approaches, the new configuration is established by the recreated pod being caused to have, e.g., loaded with, updated storage software loaded thereon. More specifically, in at least some of such approaches, the updated storage software is different than the storage software that the selected pod had at the time of the deletion, e.g., different in version number, different in software type, produced by a different software vendor, different code, etc. In the event of a storage software update, in some approaches, there are two categories of updates. Image updates and configuration updates (pod spec/configuration parameters). Image updates may introduce incompatibilities in filesystem kernel module compatibility and thus may require rebooting a node under certain conditions. The updated storage software is, in some approaches, an image update and/or a configuration update.

The pod, e.g., the recreated pod, preferably remains in a pending state after the update. This pending state may continue until a determination is made to uncordon the node. Uncordoning the node, in some approaches, includes marking the node as schedulable, e.g., see operation 316. Marking the node as schedulable, in some approaches, includes unmarking the node that was previously marked before being drained.

In some approaches, the determination is made to uncordon the node in response to a predetermined amount of time passing. In some other approaches, the determination is made to uncordon the node in response to receiving a request to do so from a device associated with an operator. For example, in some approaches, following the update, the node is uncordoned in response to a determination that a device associated with the storage operator initially performed the cordon. A node annotation may be used to determine if the storage operator cordoned the node. For context, uncordoning the node allows the storage software to return back to a functional state and start accepting application workload again.

It may be noted that although various operations are described for a single node of the orchestrated environment, in some approaches, one or more of the operations of method 300 described herein may preferably be repeated for all pods that are scheduled to be updated. In other words, one or more of the operations of method 300 may preferably be performed ongoingly in response to a determination that one or more pods are to be updated.

Although various approaches described above detail a containerized storage software update, in some approaches, a second category of update may additionally and/or alternatively be performed on the pod. For example, the updating may additionally and/or alternatively include an orchestration framework update that is based on updating an external component, e.g., an external update from the storage software. For context, an update on an external component may refer to a system update received from Kubernetes itself or from an administrator. Depending on the approach, these updates may be in the form of orchestration framework (Kubernetes and/or OPENSHIFT) updates or in the form of an administrator initiating manual maintenance procedures on a system. For example, in the realm of OPENSHIFT, there is a concept called “machine config operator”, which configures each specific node of the host. In OPENSHIFT, the operating system may be immutable and may be only modified by certain actions that the machine configuration operator can take. Accordingly, in order to take a maintenance action, e.g., such as to update the operating system, the operator may have to roll out the changes by draining the applications, the storage applications and the pods. A prime example of software that may be used for such an update is OPENSHIFT's machine configuration operator (which manages OPENSHIFT upgrades and configuration updates). When an external component requires an update, the standard procedure is to cordon and drain the node requiring an update. However, in some preferred approaches, a state of the dependent storage applications needs to be guaranteed. Accordingly, in some approaches, an ordering may be guaranteed by intercepting the update with a webhook that understands when the scheduler receives the eviction of the pod. When the node is drained, the aforementioned storage operator may be caused, e.g., instructed, to intercept the request via a webhook registered to receive notification of pod evictions. The operator/webhook marks a storage software pod with an annotation that it must be deleted. At such a point, the operator may initiate the previously mentioned storage software update process. Except in this case, the operator will not cordon/uncordon the node as it has been otherwise cordoned by another entity.

In some preferred approaches, the updating of the external component is based on registering a webhook to intercept the draining. More specifically, in some preferred approaches, a webhook is registered to intercept evictions from the Kubernetes scheduler, e.g., when another software component/some external entity initiates a drain. Upon intercepting an eviction, the storage-providing pod is marked for deletion and added into the priority queue. The storage operator may perform the aforementioned storage software update(s) pre-delete to drain the node of any storage consuming applications ahead of removing the storage-providing pod from the node. A pod disruption budget for storage-providing pods may, in some approaches, be used as a backstop to prevent deletion of any storage-providing pod by an external drain until the storage software self-removes the pod. Accordingly, in some approaches, method 300 includes establishing a disruption budget for the selected pod to prevent deletion of the selected pod by an external drain. The disruption budget allows, e.g., enables, the selected pod to self-delete during the deletion of the selected pod. Note that in an alternative approach, method 300 may additionally and/or alternatively include establishing a webhook for the selected pod to prevent deletion of the selected pod by an external drain. In such an approach, the webhook allows, e.g., enables the selected pod to self-delete during the deletion of the selected pod. Although the eviction may be approved by the webhook (which acts as a pass-through notification), the eviction may not be approved by the disruption budget. This backstop allows the storage operator to avoid race conditions and stale state drawbacks that are otherwise experienced in conventional updating techniques. This allows the storage operator to satisfy the requirements of the priority queue/safety checks as well as guarantee that storage-consuming pods have been migrated ahead of removing the storage providing pod, e.g., blocking the external drain until it is safe to proceed.

Following the deletion of the storage pod, the drain may proceed according to normal functional operations.

In one use case, the operations of method 300 may be performed for an update that is performed across a RED HAT OPENSHIFT cluster, an IBM SPECTRUM SCALE cluster, and/or an IBM SPECTRUM SCALE core pod. These updates may be integrated into a consistent procedure that includes cordoning a node as unschedulable, draining the node (move workloads), deleting an associated storage pod, rebooting (if necessary), and uncordoning the node as schedulable. After the node is schedulable, IBM SPECTRUM SCALE and IBM SPECTRUM SCALE CSI pods may start. In some approaches, applications may fail to attach storage while the system is starting.

Various benefits are enabled as a result of implementing the techniques described herein in an orchestrated environment. For example, it should be noted that conventional techniques, e.g., a canary deployment mechanism, for performing updates in an orchestrated environment merely apply a “best guess” approach to determining what is occurring in an orchestrated environment. In sharp contrast, the techniques of embodiments and approaches described herein enable a guaranteed mechanism to understand the requests of a system, and more specifically an understanding of when a disruption to storage software is requested by a scheduler, e.g., by using the evictions that are determined by the webhook to recognize the disruption. This guarantee avoids relatively excessive restarts of pods and enables updates to be relatively more granularly managed based on guaranteeing an understanding of who is updating a system. For example, based on this understanding, an external update versus an internal update is able to be recognized and thereby an appropriate response may be performed. Without this understanding, e.g., based on otherwise using the best guess approach, an incorrect response may be performed which would otherwise cause unnecessary pod restarts to be performed. Accordingly, using the techniques described herein, system performance within the orchestrated environment improves because unnecessary pod restarts are mitigated.

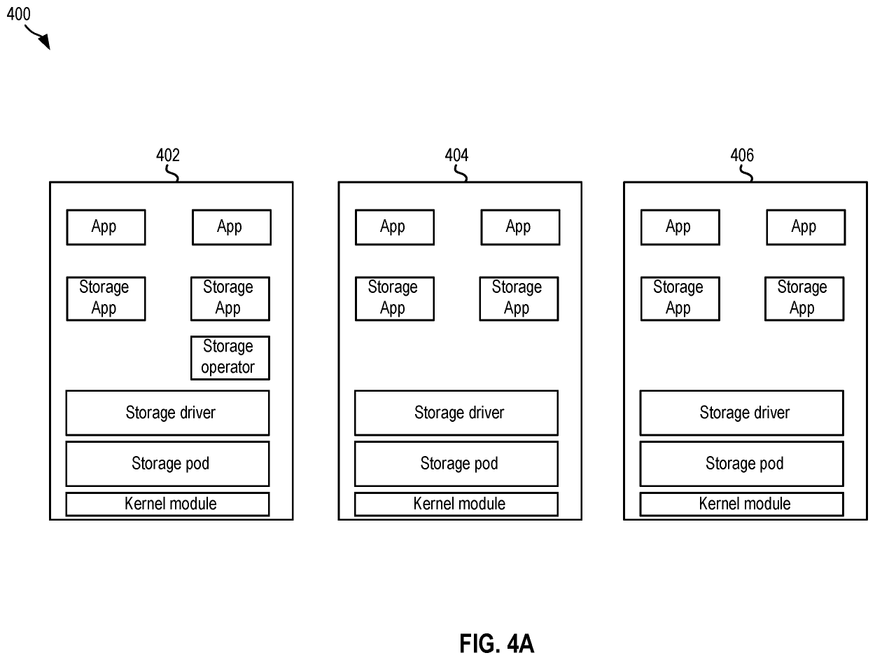

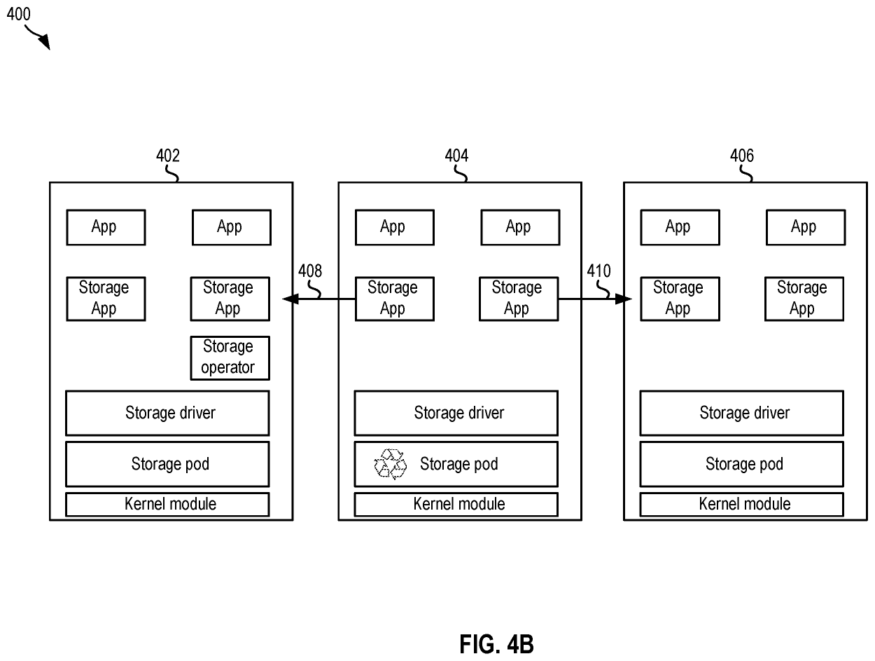

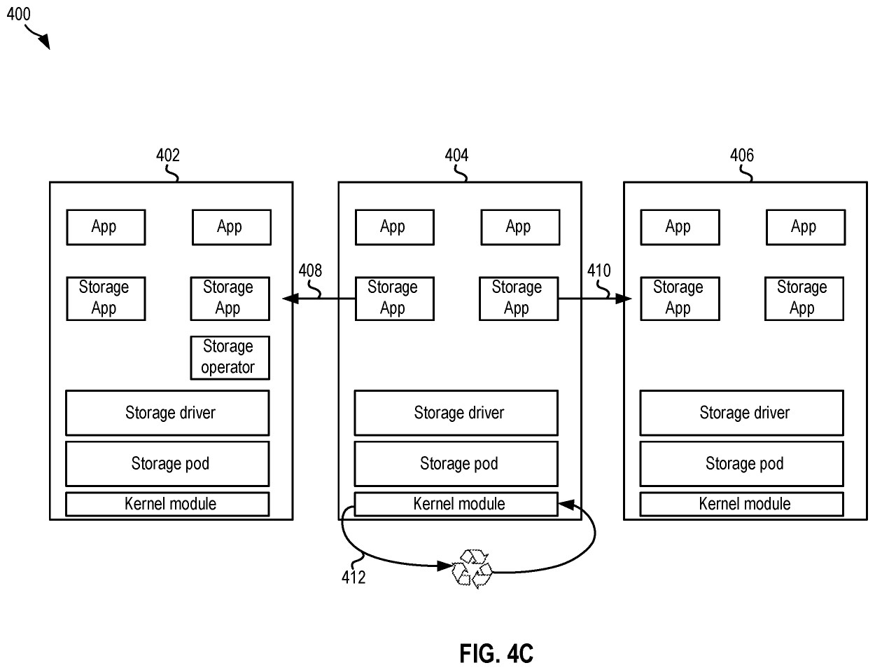

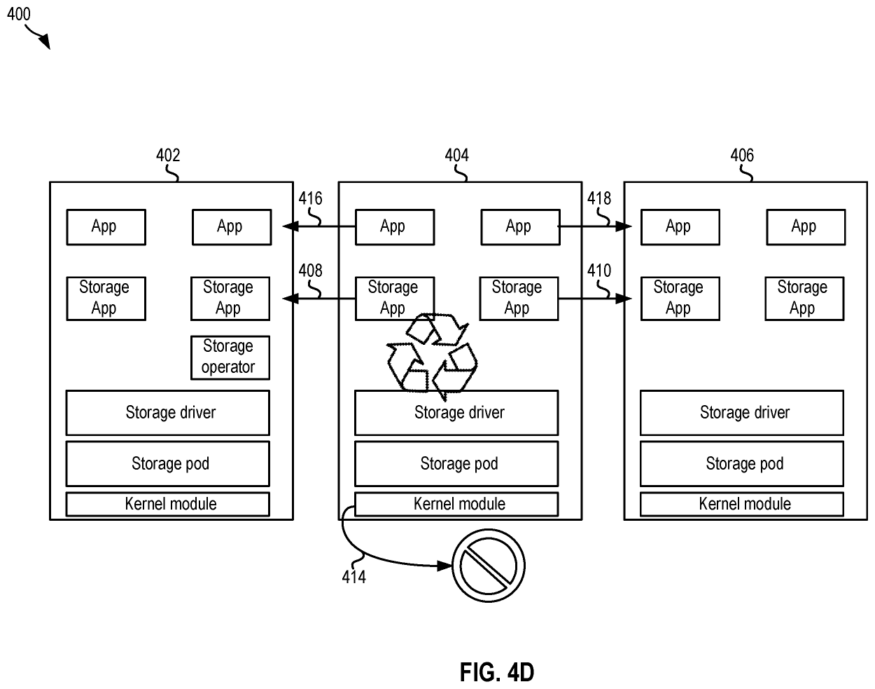

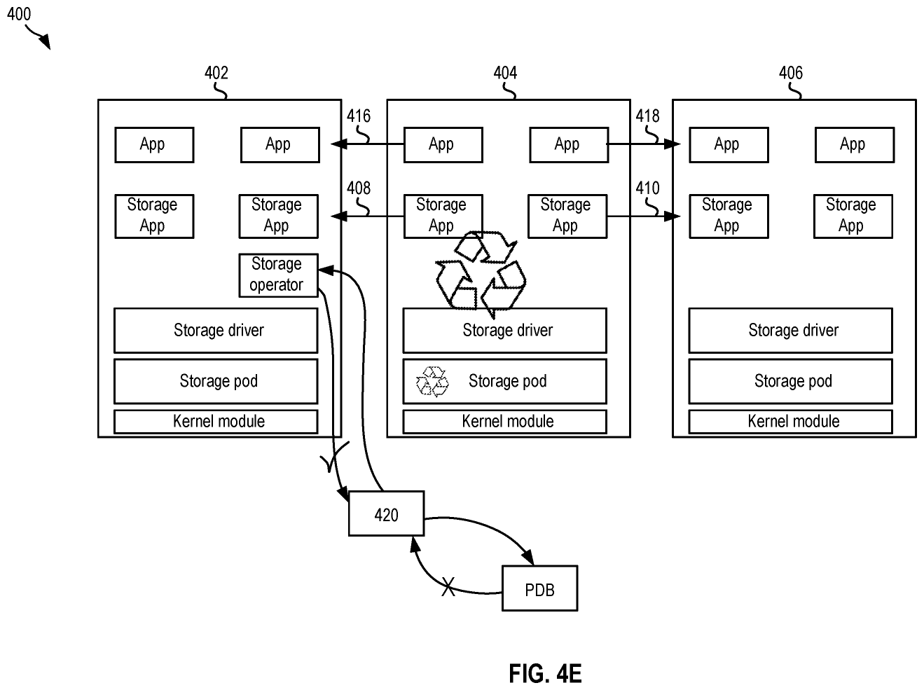

FIGS. 4A-4E depict an orchestrated environment 400, in accordance with several embodiments. As an option, the present orchestrated environment 400 may be implemented in conjunction with features from any other embodiment listed herein, such as those described with reference to the other FIGS. Of course, however, such orchestrated environment 400 and others presented herein may be used in various applications and/or in permutations which may or may not be specifically described in the illustrative embodiments listed herein. Further, the orchestrated environment 400 presented herein may be used in any desired environment.

Referring now to FIG. 4A, the orchestrated environment 400, in some preferred approaches, includes a plurality of nodes, e.g., a first node 402, a second node 404, and a third node 406. The first node includes a storage operator. Furthermore, each of the nodes includes applications, e.g., see App and Storage App, a storage driver, a storage pod, and a kernel module. Note that although three nodes are shown in the current embodiment, in some other embodiments the orchestrated environment 400 may alternatively include, e.g., at least two nodes, four nodes, five nodes, etc.

Referring now to FIG. 4B, a storage pod specification update is shown being performed on the second node of the orchestrated environment 400. In order to perform the update, in some approaches, the second node is marked as not schedulable. Furthermore, storage application workloads of the second node are drained and migrate to the first node and the third node, e.g., see operations 408 and 410. The storage pod of the second node is deleted after the draining of the storage application workloads. The second pod is thereafter recreated with a new configuration and updated with updated storage software. Once the update is complete, the node is marked as schedulable, and is thereby able to receive application workloads.

Referring now to FIG. 4C, the storage pod specification update is illustrated to be an image update, e.g., see operation 412. Specifically, an image update is performed on the second node with a successful kernel module (kmod) unload. In contrast, referring now to FIG. 4D, an image update is shown being performed on the second node with an unsuccessful kmod unload, e.g., see operation 414. Furthermore, both the storage application workload and regular application workload is drained from the second node, e.g., see operations 416 and 418.

Referring now to FIG. 4E, an external drain is performed on the second node. The storage operator drains any storage applications not already drained by an external drain. The storage operator does not drain non-storage applications here.

An eviction of storage pods on the second node is intercepted in operation 420. Furthermore, a pod disruption budget, e.g., see “PDB”, disallows the eviction. The PDB is, in some approaches, unblocked by a recycle during the update. In contrast, a webhook allows the eviction and denotes the eviction, but the eviction is always disallowed from another point of view. In some approaches, the storage operator is caused, e.g., instructed, to determine when the eviction is safe to perform and deletes the pod instead of having the pod evicted. This way the disruption budget has no effect because while the disruption budget does not allow the eviction, the pod is otherwise removed, e.g., see operation 420.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting information from a storage cluster associated with pod deletion candidacy;
selecting a pod for deletion based on pod priorities determined using the collected information;
marking a node associated with the selected pod as not schedulable;
draining the node of application workloads;
deleting the selected pod;
recreating the selected pod with a new configuration;
updating the recreated pod with updated storage software; and
marking the node as schedulable.

2. The computer-implemented method of claim 1, comprising: inserting the information in a priority queue structure for determining the pod priorities, wherein the pod priorities are based on a count of checks registered with the priority queue structure.

3. The computer-implemented method of claim 2, wherein the checks are static and dynamic.

4. The computer-implemented method of claim 1, wherein the updated storage software is selected from the group consisting of: an image update and a configuration update.

5. The computer-implemented method of claim 1, wherein the updating includes an orchestration framework update that is based on updating an external component.

6. The computer-implemented method of claim 5, wherein the updating of the external component is based on registering a webhook to intercept the draining.

7. The computer-implemented method of claim 6, comprising: establishing a disruption budget for the selected pod to prevent deletion of the selected pod by an external drain, wherein the disruption budget allows the selected pod to self-delete.

8. The computer-implemented method of claim 6, comprising: establishing a webhook for the selected pod to prevent deletion of the selected pod by an external drain, wherein the webhook allows the selected pod to self-delete.

9. A computer program product, the computer program product comprising a computer readable storage medium having program instructions embodied therewith, the program instructions readable and/or executable by a computer to cause the computer to:
collect information from a storage cluster associated with pod deletion candidacy;
select a pod for deletion based on pod priorities determined using the collected information;
mark a node associated with the selected pod as not schedulable;
drain the node of application workloads;
delete the selected pod;
recreate the selected pod with a new configuration;
update the recreated pod with updated storage software; and
mark the node as schedulable.

10. The computer program product of claim 9, the program instructions readable and/or executable by the computer to cause the computer to: insert the information in a priority queue structure for determining the pod priorities, wherein the pod priorities are based on a count of checks registered with the priority queue structure.

11. The computer program product of claim 10, wherein the checks are static and dynamic.

12. The computer program product of claim 9, wherein the updated storage software is selected from the group consisting of: an image update and a configuration update.

13. The computer program product of claim 9, wherein the updating includes an orchestration framework update that is based on updating an external component.

14. The computer program product of claim 13, wherein the updating of the external component is based on registering a webhook to intercept the draining.

15. The computer program product of claim 14, the program instructions readable and/or executable by the computer to cause the computer to: establish a disruption budget for the selected pod to prevent deletion of the selected pod by an external drain, wherein the disruption budget allows the selected pod to self-delete.

16. The computer program product of claim 14, the program instructions readable and/or executable by the computer to cause the computer to: establish a webhook for the selected pod to prevent deletion of the selected pod by an external drain, wherein the webhook allows the selected pod to self-delete.

17. A system, comprising:
a processor; and
logic integrated with the processor, executable by the processor, or integrated with and executable by the processor, the logic being configured to:
collect information from a storage cluster associated with pod deletion candidacy;
select a pod for deletion based on pod priorities determined using the collected information;
mark a node associated with the selected pod as not schedulable;
drain the node of application workloads;
delete the selected pod;
recreate the selected pod with a new configuration;
update the recreated pod with updated storage software; and
mark the node as schedulable.

18. The system of claim 17, the logic being configured to: insert the information in a priority queue structure for determining the pod priorities, wherein the pod priorities are based on a count of checks registered with the priority queue structure.

19. The system of claim 18, wherein the checks are static and dynamic.

20. The system of claim 17, wherein the updated storage software is selected from the group consisting of: an image update and a configuration update.
